(19) United States
(12) Patent Application Publication
(10) Pub. No.: US 2023/0027435 A1
(43) Pub. Date: Jan. 26, 2023

(54) SYSTEMS AND METHODS FOR NOISE COMPENSATION OF RADAR SIGNALS

(71) Applicant: A^3 by Airbus, LLC, Sunnyvale, CA (US)

(72) Inventors: Cedric Cocaud, SunnyVale, CA (US); Arne Stoschek, Palo Alto, CA (US); Navneet Sankarambadi, Sunnyvale, CA (US); Alexander Dean Naiman, Santa Clara, CA (US); Harvest Zhang, Sunnyvale, CA (US)

(73) Assignee: A^3 by Airbus, LLC, Sunnyvale, CA (US)

(21) Appl. No.: 17/788,666

(22) PCT Filed: Dec. 23, 2019
(86) PCT No.: PCT/US19/68385

§ 371 Date: Jun. 23, 2022

(51) Int. Cl. G01S 13/933; G01S 13/86; G01S 7/41

(52) U.S. Cl. CPC G01S 13/933; G01S 13/867; G01S 7/411

(57) ABSTRACT

A monitoring system for an aircraft can include an image sensor and a radar sensor. The system can provide noise compensation to a radar sample corresponding to a return radar signal received by the radar sensor based on information detected by the image sensor. The system can identify one or more object types in the image captured by the image sensor and then translate the identified object types to corresponding positions on a map. The system can correlate the radar sample to a position on the map and any object type located at that position can be identified. The system can then select a noise pattern that corresponds to the identified object type from the map and use the selected noise pattern to compensate the radar sample.

### BACKGROUND

An aircraft may encounter a wide variety of collision risks during flight, such as debris, other aircraft, equipment, buildings, birds, terrain, and/or other objects, any of which may cause damage to the aircraft, damage to cargo carried by the aircraft, and/or injury to passengers in the aircraft. Because objects may approach and impact the aircraft from any direction, sensors on the aircraft can be used to detect objects that pose a collision risk with the aircraft and to warn a pilot of the detected collision risks. If the aircraft is self-piloted, sensor data indicative of objects around the aircraft may be used by a controller to avoid collisions with the detected objects.

One type of sensor system that can be used on an aircraft to detect objects that may collide with the aircraft is a radio detection and ranging (radar) system. A radar system works by transmitting electromagnetic waves such as radio waves (or microwaves) and determining the location and speed of objects (such as aircraft, buildings or terrain) based on reflected radio waves received back at the radar system (sometimes referred to as radar returns). A radar system can effectively identify objects when scanning away from the surface (e.g., during takeoff of the aircraft) or when scanning parallel to the surface (e.g., during flight of the aircraft at a cruising altitude). However, when the radar system of an aircraft is scanning toward the surface (e.g., during the descent or landing of the aircraft), the ability of the radar system to identify objects located between the aircraft and the surface (e.g., a drone flying at a lower altitude than the aircraft) is greatly reduced by the presence of noise in the return radar signal. The noise in the radar return signal occurs as a result of reflections caused by the terrain and/or objects on the surface (sometimes referred to as ground clutter).

In some situations, the noise in the radar return signal caused by ground clutter can have a magnitude sufficiently large such that the radar system erroneously makes a determination that an object is present between the aircraft and the surface, even though there is no object actually present between the aircraft and the surface. The erroneous detection of an object by the radar system can be referred to as a false positive and may result in an unnecessary diversion from the aircraft's flight path. If the radar system makes too many false positives during a descent or landing process due to the presence of ground clutter, the usefulness of the radar system when piloting the aircraft is greatly reduced.

Therefore, solutions allowing for the compensation of noise caused by ground clutter and the reduction of the number of false positives determined by the radar system are generally desired.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure.

FIG. 1 shows a perspective view of an aircraft having an aircraft monitoring system in accordance with some embodiments of the present disclosure.

FIG. 2 is a block diagram showing various components of an aircraft monitoring system in accordance with some embodiments of the present disclosure.

FIG. 3 is a block diagram showing various components of a sense and avoid element in accordance with some embodiments of the present disclosure.

FIG. 4 is a diagram schematically showing an image captured by an image sensor in accordance with some embodiments of the present disclosure.

FIG. 5 is a diagram schematically showing a map of object types based on the image of FIG. 4 in accordance with some embodiments of the present disclosure.

FIG. 6 is a flow chart illustrating a method for processing sensor data in accordance with some embodiments of the present disclosure.

FIG. 7 is a flow chart illustrating a method for processing sensor data from image sensors in accordance with some embodiments of the present disclosure.

FIG. 8 is a flow chart illustrating a method for processing sensor data from radar sensors in accordance with some embodiments of the present disclosure.

FIG. 9 is a perspective view showing aircraft descending for a landing in accordance with some embodiments of the present disclosure.

### DETAILED DESCRIPTION

The present disclosure generally pertains to vehicular systems, such as aircraft, and methods for compensating for noise in radar returns received by the vehicular system. The noise in the radar returns can result from reflections of the transmitted radar signal off of objects and textures on the surface (e.g., ground clutter). In some embodiments, an aircraft includes an aircraft monitoring system having sensors that are used to sense the presence of objects around the aircraft for collision avoidance, navigation, or other purposes. At least one of the sensors is part of a radar system that can transmit and receive radar signals and at least one other of the sensors is an image sensor, such as a camera, that can capture an image of a scene oriented in the same direction as the radar signal such that the field of regard of the radar signal is encompassed within the field of view of the image sensor.

The aircraft monitoring system can process the image data for the captured image from the image sensor to identify one or more object types in the captured image. Depending on the resolution of the image and/or the processing capabilities of the system, the identification of the object types can be more general (e.g., a canopy, body of water, grassland, building, etc.) or more granular (e.g., pine tree, rain forest, concrete façade building, etc.). The identified object types from the image can then be translated into a two-dimensional map that provides locations (e.g., coordinates) for each of the identified object types from the captured image.

The aircraft monitoring system can then use the information about the object types on the map to provide noise compensation to a return radar signal (or radar sample) received by the system. The system can determine a location where the transmitted radar signal was sent and correlate the location of the transmitted radar signal to a corresponding positon on the map. The system can then determine whether there is a specific type of object located at the corresponding position on the map for the transmitted radar signal. If there is a specific type of object at the corresponding position on the map, the system can then select a predefined noise pattern that corresponds to the specific object type and use the selected noise pattern to compensate for noise in the return radar signal that may result from the transmitted radar signal reflecting off of the specific object type. Each specific object type can have a specific noise pattern that corresponds to the noise that is introduced into the return radar signal by the reflection of the transmitted radar signal off of the specific object type. Each noise pattern for a specific object type may correspond to the reflections off of the specific object type for a specific angle of incidence of the transmitted radar signal. If the angle of incidence associated with a return radar signal does not match the angle of incidence for the selected noise pattern, the selected noise pattern may be adjusted to account for the difference in the angle of incidence since the noise in the return radar signal associated with a specific object type can vary based on the angle of incidence. In one embodiment, the selected noise pattern can be adjusted to account for the angle of incidence of the transmitted radar signal prior to performing the compensation on the return radar signal. If no specific object type is located at the corresponding position on the map, the system can process the signal without noise compensation. The system can then provide the compensated radar signal (or the uncompensated radar signal) to an aircraft flight control system, which may include a sense and avoid system, that uses the radar signal (and other sensor measurements) to control the flight of the aircraft.

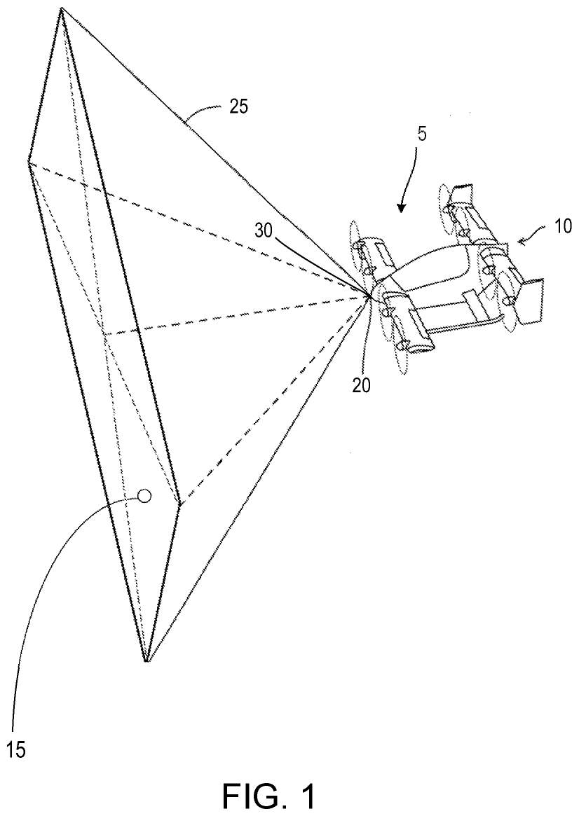

FIG. 1 shows a perspective view of an aircraft 10 having an aircraft monitoring system 5 in accordance with some embodiments of the present disclosure. The aircraft 10 may be of various types, but in the embodiment of FIG. 1, the aircraft 10 is shown as an autonomous vertical takeoff and landing (VTOL) aircraft 10. The aircraft 10 may be configured for carrying various types of payloads (e.g., passengers, cargo, etc.). In addition, the aircraft 10 may be manned or unmanned, and may be configured to operate under control from various sources.

In the embodiment of FIG. 1, the aircraft 10 is configured for self-piloted (e.g., autonomous) flight. As an example, aircraft 10 may be configured to perform autonomous flight by following a predetermined route (or flight path) to its destination. The aircraft monitoring system 5 is configured to communicate with a flight controller (not shown in FIG. 1) on the aircraft 10 to control the aircraft 10 during the flight. In other embodiments, the aircraft 10 may be configured to operate under remote control, such as by wireless (e.g., radio) communication with a remote pilot. Various other types of techniques and systems may be used to control the operation of the aircraft 10. Exemplary self-piloted aircraft are described by U.S. patent application Ser. No. 16/302,263, entitled “Self-Piloted Aircraft for Passenger or Cargo Transportation” and filed on Nov. 16, 2018, which application is incorporated herein by reference.

The aircraft 10 can have one or more radar sensors 20 (as part of one or more radar systems) for monitoring the space around aircraft 10, and one or more sensors 30 for providing redundant sensing of the same space or sensing of additional spaces. In one embodiment, the sensors 30 may include any optical or non-optical sensor for detecting the presence of objects or obtaining a 2-dimensional image of an area external to the aircraft. (e.g., a camera, an electro-optical (EO) sensor, an infrared (IR) sensor, a LIDAR sensor, or other sensor type). In other embodiments, the aircraft 10 may use other sensors, devices or systems as needed for safe and efficient operation of the aircraft 10.

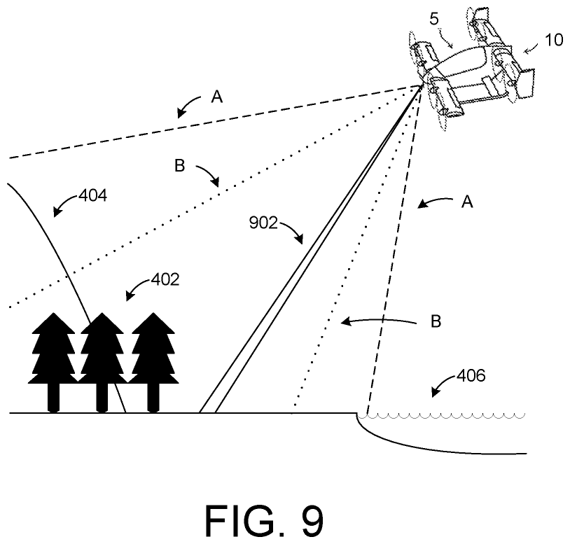

Each sensor 20, 30 may have a field of view (or field of regard) 25 that generally refers to the region over which the sensor 20, 30 is capable of sensing objects, regardless of the type of sensor that is employed. Further, although the field of view (FOV) 25 is shown in FIG. 1 as being relatively rectangular or polygonal and the same for sensors 20, 30, the shape and/or range of the FOV of each sensor 20, 30 may vary in different embodiments (see e.g., FIG. 9). In alternate embodiments, the capabilities (e.g., field of view, field of regard, resolution, zoom, signal strength, etc.) of different sensors 20, 30 installed on the aircraft 10 may vary. For example, when sensors 30 include more than one image sensor (e.g., a camera), the field of view of the image sensors 30 may differ based on properties of the image sensors 30 (e.g., lens, focal length, etc.). In some embodiments, the image sensors 30 may be in a fixed position so as to have a fixed field of view, however, in other embodiments, image sensors 30 may be controllably movable (e.g., mounted on a gimbal) so as to monitor different fields of view at different times.

The sensors 20, 30 may sense the presence of an object 15 within the sensor's respective field of view or field of regard 25 and provide sensor data indicative of a location of any object 15 within the corresponding field. For example, if image sensor 30 includes a camera, the camera can capture images of a scene and provide data defining the captured scene. The sensor data may then be processed by the system 5 to determine whether the object 15 is within a certain vicinity of the aircraft 10, such as near a flight path of the aircraft 10, and presents a collision threat to the aircraft 10. The object 15 may be of various types that aircraft 10 may encounter during flight, for example, another aircraft (e.g., a drone, airplane, or helicopter), a bird, debris, building or terrain, or any other of various types of objects that may damage the aircraft 10, or impact its flight, if the aircraft 10 and the object 15 were to collide. The object 15 shown in FIG. 1 is a single object that has a specific size and shape, but it will be understood that object 15 may represent one or several objects at any location within the corresponding field, and object(s) 15 may take any of a variety of shapes or sizes and may have various characteristics (e.g., stationary or mobile, cooperative or uncooperative).

Although only one of each sensor 20, 30 is shown in FIG. 1 for ease of illustration, any number of sensors 20, 30, and any number of types of sensors, may be used. The use of additional sensors 20, 30 may expand the area in which the aircraft monitoring system 5 can detect objects. In general it will be understood that the sensors 20, 30 are arranged to provide full coverage of the (roughly-spherical) space around the aircraft 10. To that end, sensors 20, 30 may be placed at different parts of the aircraft 10 (e.g., top and bottom, front and back, etc.), in order for each respective sensor 20, 30 to obtain information about a different portion of the space surrounding the aircraft 10. In one embodiment, little or no overlap may be present in the areas monitored by respective sensors 20, 30, nor is any area left unmonitored (that is, no blind spots exist); however, other arrangements may be possible in other embodiments.

The aircraft monitoring system 5 may use information about any sensed object 15, such as its location, velocity, and/or probable classification (e.g., that the object is a bird, aircraft, debris, building, etc.) from the sensors 20, 30, along with information about the aircraft 10, such as the current operating conditions of the aircraft (e.g., airspeed, altitude, orientation (such as pitch, roll, or yaw), throttle settings, available battery power, known system failures, etc.), capabilities of the aircraft (e.g., maneuverability) under the current operating conditions, weather, restrictions on airspace, etc., to generate one or more paths (including modifications of an existing path) that the aircraft is capable of flying under its current operating conditions. This may, in some embodiments, take the form of a possible path (or range of paths) that aircraft 10 may safely follow in order to avoid the detected object 15.

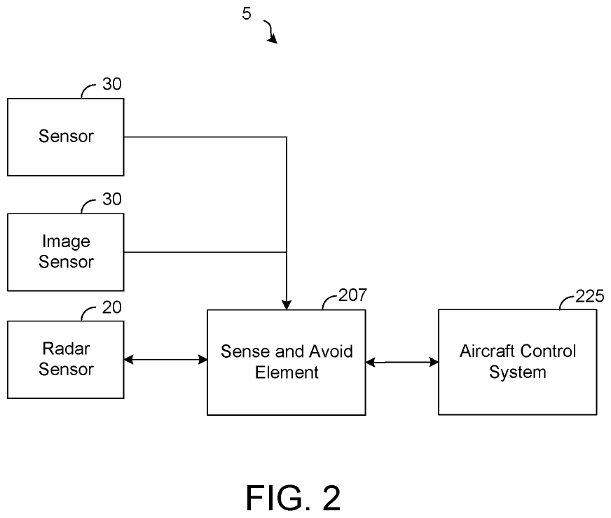

FIG. 2 is a block diagram illustrating various components of an aircraft monitoring system 5 in accordance with some embodiments of the present disclosure. As shown by FIG. 2, the aircraft monitoring system 5 may include a sense and avoid element 207, a plurality of sensors 20, 30, and an aircraft control system 225. Although particular functionality may be attributed to various components of the aircraft monitoring system 5, it will be understood that such functionality may be performed by one or more components of the system 5 in some embodiments. In addition, in some embodiments, components of the system 5 may reside on the aircraft 10 or otherwise, and may communicate with other components of the system 5 via various techniques, including wired (e.g., conductive), optical, or wireless communication. Further, the system 5 may include various components not specifically depicted in FIG. 2 for achieving the functionality described herein and generally performing threat-sensing operations and aircraft control.

In some embodiments, as shown by FIG. 2, the sense and avoid element 207 may be coupled to each sensor 20, 30, to process the sensor data from the sensors 20, 30, and provide signals to the aircraft control system 225. The sense and avoid element 207 may be various types of devices capable of receiving and processing sensor data from sensors 20, 30. The sense and avoid element 207 may be implemented in hardware or a combination of hardware and software/firmware. As an example, the sense and avoid element 207 may include one or more application-specific integrated circuits (ASICs), field-programmable gate arrays (FPGAs), microprocessors programmed with software or firmware, or other types of circuits for performing the described functionality.

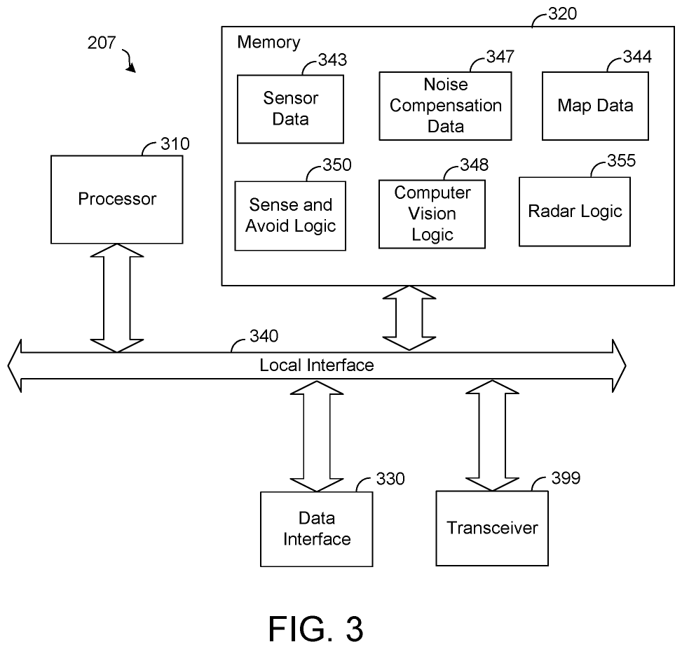

The sense and avoid element 207 of aircraft monitoring system 5 can collect and interpret sensor data from sensors 20, 30 to detect objects and determine whether a detected object is a collision threat to the aircraft, and, if so, to provide a recommendation of an action to be taken by the aircraft to avoid collision with the sensed object. In one embodiment, the sense and avoid element 207 can provide information about a detected object (such as the object's classification, attributes, location information, and the like) to a path planning system (not specifically shown) that may perform processing of such data (as well as other data, e.g., flight planning data (terrain and weather information, among other things) and/or data received from an aircraft control system) to generate a recommendation for an action to be taken by the aircraft control system 225. An exemplary configuration of the sense and avoid element 207 will be described in more detail below with reference to FIG. 3.

In some embodiments, the aircraft control system 225 may include various components (not specifically shown) for controlling the operation of the aircraft 10, including the velocity and route of the aircraft 10 based on instructions from the path planning system. As an example, the aircraft control system 25 may include thrust-generating devices (e.g., propellers), flight control surfaces (e.g., one or more ailerons, flaps, elevators, and rudders) and one or more controllers and motors for controlling such components. The aircraft control system 225 may also include sensors and other instruments for obtaining information about the operation of the aircraft components and flight.

FIG. 3 depicts a sense and avoid element 207 in accordance with some embodiments of the present disclosure. As shown by FIG. 3, the sense and avoid element 207 may include one or more processors 310, memory 320, a data interface 330, a local interface 340 and a transceiver 399. The processor 310 may be configured to execute instructions stored in memory 320 in order to perform various functions, such as processing of sensor data from the sensors 20, 30. The processor 310 may include a central processing unit (CPU), a digital signal processor (DSP), a graphics processing unit (GPU), an FPGA, other types of processing hardware, or any combination thereof. Further, the processor 310 may include any number of processing units to provide faster processing speeds and redundancy. The processor 310 may communicate to and drive the other elements within the sense and avoid element 207 via the local interface 340, which can include at least one bus. The data interface 330 (e.g., ports or pins) may interface components of the sense and avoid element 207 with other components of the system 5, such as the sensors 20, 30. The transceiver 399 may be used to permit the sense and avoid element 207 to communicate with other aircrafts for purposes of sharing information among the aircrafts about detected objects and/or the paths of the aircrafts.

As shown by FIG. 3, the sense and avoid element 207 may include sense and avoid logic 350, computer vision logic 348 and radar logic 355, each of which may be implemented in hardware, software, firmware or any combination thereof. In FIG. 3, the sense and avoid logic 350, computer vision logic 348 and radar logic 355 are implemented in software and stored in memory 320 for execution by at least one processor 310. However, other configurations of the sense and avoid logic 350, computer vision logic 348 and radar logic 355 are possible in other embodiments.

Note that the sense and avoid logic 350, computer vision logic 348 and radar logic 355, when implemented in software, can be stored and transported on any computer-readable medium for use by or in connection with an instruction execution apparatus that can fetch and execute instructions. In the context of this document, a “computer-readable medium” can be any means that can contain or store code for use by or in connection with the instruction execution apparatus.

The sense and avoid logic 350 is configured to receive sensor data 343 that was sensed by sensors 20, 30 and/or processed, as needed, by computer vision logic 348 and/or radar logic 355, detect for the presence of any objects in the sensor data 343, classify, if needed, any detected objects based on the sensor data 343, assess whether there is a collision risk between the detected object(s) and the aircraft 10, and generate one or more paths for the aircraft 10 in view of the assessed collision risk and other available information. In one embodiment, the sense and avoid logic 350 is configured to identify a collision threat based on various information such as the object's location and velocity.

In some embodiments, the sense and avoid logic 350 is configured to classify a detected object in order to better assess the detected object's possible flight performance, such as speed and maneuverability, and threat risk. In this regard, the sense and avoid element 207 may store object data (not shown) indicative of various types of objects, such as birds or other aircraft, that might be encountered by the aircraft 10 during flight. For each object type, the object data defines a signature that can be compared to sensor data 343 to determine when a sensed object corresponds to the object type.

The sense and avoid logic 350 is configured to process sensor data 343 dynamically as new data becomes available. As an example, when sense and avoid element 207 receives new data from sensors 20, 30 or when new processed data from computer vision logic 348 or radar logic 355 is generated, the sense and avoid logic 350 processes the new data and updates any previously made determinations as may be necessary. The sense and avoid logic 350 may thus update an object's location, velocity, threat envelope, etc. when it receives new information from sensors 20, 30. Thus, the sensor data 343 is repetitively updated as conditions change.

The computer vision logic 348 can receive sensor data 343 from sensors 30 and process the sensor data 343 with pattern recognition, segmentation or edge detection software to identify the location and types of objects that may be present in images of a scene captured by the sensors 30. In one embodiment, the sensors 30 can include one or more image sensors, such as cameras, that can include one or more CCDs (charge coupled devices) and/or one or more active pixel sensors or CMOS (complementary metal-oxide-semiconductor) sensors. The images of the scene from the image sensors 30 can be stored as image data in sensor data 343 in memory 320. In one embodiment, the image data may define frames of the captured images. The image data can be stored in any appropriate file format, including, but not limited to, PNG (portable network graphics), JPEG (joint photographic experts group), TIFF (tagged image file format), MPEG (moving picture experts group), WMV (Windows media video), QuickTime and GIF (graphics interchange format).

The computer vision logic 348 can be used to analyze and process the image data from the image sensors 30 stored in sensor data 343. The computer vision logic 348 can extract information from the image data using models, theories and other techniques to identify or recognize object types present in the captured image. The computer vision logic 348 can use numerous techniques to identify or recognize object types such as content-based image retrieval, optical character recognition, 2D code reading, shape recognition, object recognition, pattern recognition and any other appropriate identification or recognition technique.

In one embodiment, the computer vision logic 348 can perform one or more of the following techniques and/or processes on the image data: pre-processing; feature extraction; detection/segmentation; high-level processing; and decision making. The pre-processing of the image data can involve the processing of the data to confirm that the data is in the proper form for subsequent actions. Some examples of pre-processing actions can include noise reduction and contrast enhancement. After the image data has been pre-processed, the image data can be reviewed or analyzed to extract features (e.g., lines, edges, corners, points, textures and/or shapes) of various complexity from the image data. Next, in the detection/segmentation step, decisions can be made regarding the features and/or regions that are relevant and require additional processing. The high-level processing of the reduced set of image data (as a result of the detection/segmentation step) involves the estimation of specific parameters (e.g., object size) and classifying of a detected object into categories. Finally, the decision making step makes a determination of the identity of the detected object or surface texture or a determination that the detected object or surface texture is not known.

The computer vision logic 348 can identify object types that are present in the image data by processing the individual images received from an image sensor 30 and/or any combined or grouped images based on image data from multiple image sensors 30. In an embodiment, the computer vision logic 348 can identify object types in the image data by identifying profiles or features of the object type in the image data and then compare the identified profiles or features of the object type to stored information in memory 320 correlating information on features and/or profiles to an object type.

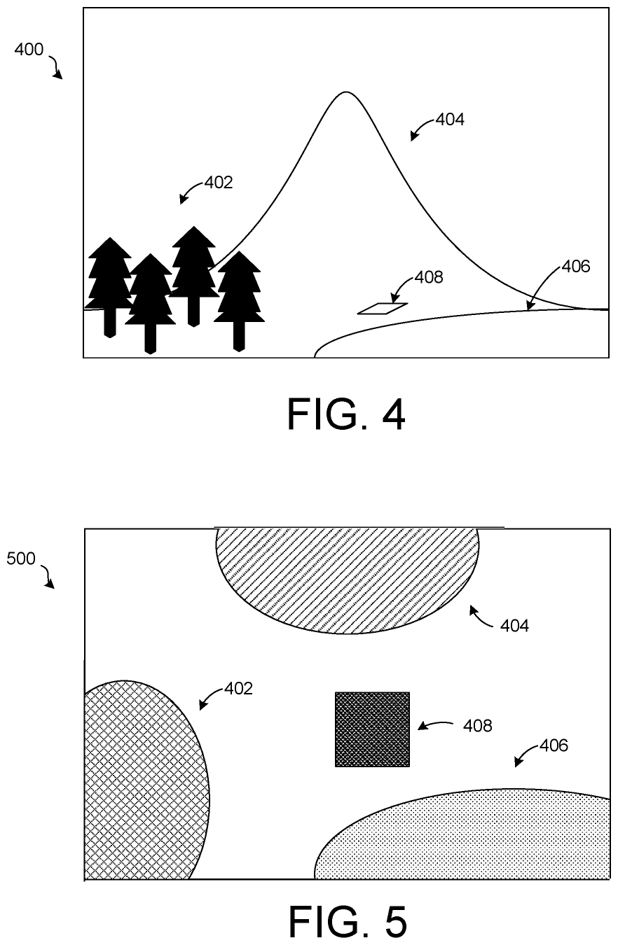

In one embodiment, the computer vision logic 348 can generate a two-dimensional map of the area in the image captured by the image sensor 30 and store the map in map data 344. The computer vision logic 348 can translate the identified object types from the image data and captured image to corresponding locations on the map such that the map can provide a location for the different object types in the scene that may reflect a transmitted radar signal. For example, FIG. 4 shows an image 400 captured by an image sensor 30. The image 400 shown in FIG. 4 can include a wooded area or canopy 402 having a plurality of trees and/or other similar vegetation, a mountainous area 404 having one or more mountains, hills, peaks and/or other similar topographical features, a water area 406 having one or more oceans, lakes, ponds, rivers, streams and/or other similar bodies of water, and a landing area 408 having one or more landing pads, runways, and/or other similar areas for an aircraft to land. In one embodiment, the wooded area 402, the mountainous area 404, the water area 406 and the landing area 408 can be identified by the computer vision logic 348 as different object types (e.g., different surface textures or individual objects) in the image 400.

The computer vision logic 348 can take the identified object types from the image 400 and create a map of the area captured in the image 400 that provides locations for the identified object types. For example, FIG. 5 shows a map 500 created by the computer vision logic 348 based on the captured image 400. The map 500 shown in FIG. 5 can provide corresponding locations for the wooded area or forest 402, the mountainous area 404, the water area 406, and the landing area 408. The map 500 can use a defined coordinate system to identify any point on the map. Thus, for each object type shown on map 500, a point on the outer edges or a point within the corresponding interior portion of the region associated with the object type can be particularly identified using the coordinate system. As shown in FIG. 5, each region associated with an object type shown on map 500 can have a corresponding outline (or perimeter) that defines the location of the object type and a corresponding pattern (or fill) within the outline or perimeter of the object type that defines the particular type of object. If the computer vision logic 348 cannot identify an object type from the image 400 that corresponds to certain areas of map 500, those areas of the map 500 may be left without an indicator (e.g., white space) or have an indicator corresponding to a determination that there is no identified object type. In another embodiment, the map 500 may be stored in a data format (e.g., table, database, etc.) with a series of coordinates and corresponding numerical identifiers for the object types (or unidentified object types) associated with each set of coordinates.

The radar logic 355 can be used to process the radar returns received by radar sensor 20. In one embodiment, the radar logic 355 can compensate for noise (e.g., ground clutter) in the radar returns resulting from the transmitted radar signal reflecting off of different object types (e.g., a canopy, a grassy area, a body of water, etc.). Each of the different object types can introduce a different noise signature in the returns. The different noise signatures from the different object types are a result of the different properties of each object type, which result in different types of reflections of the transmitted radar signal by the object type. In addition, the angle of incidence of the transmitted radar signal can affect the noise signature introduced in the returns by the object type with different angle of incidences in the transmitted radar signal resulting in different noise signatures being introduced in the returns by the object type. That is, the noise pattern actually introduced by a certain object or group of objects is a function of object type and the angle of incidence of the radar signal on the object or group of objects. The radar logic 355 can provide noise compensation to a radar return by selecting or determining the appropriate noise pattern from memory 320 based on object type, adjust the noise pattern based on angle of incidence, and then mathematically remove the noise from the return using the adjusted noise pattern (e.g., by subtracting the adjusted noise pattern from the return). A noise pattern for each of the different object types identifiable by computer vision logic 348 can be stored in memory and can correspond to the expected noise signature introduced into the return by the object type. By subtracting the noise pattern from the return, some or all of the noise signature introduced into the return by the object type can be removed from the return. In one embodiment, the radar logic 355 can be used to provide noise compensation to the returns whenever the aircraft 10 transmits a radar signal toward the surface (e.g., when operating in a cruise mode (e.g., flying at relatively consistent altitude) and attempting to locate objects below the aircraft 10 or when operating in a landing mode (e.g., descending from the cruising altitude toward the surface).

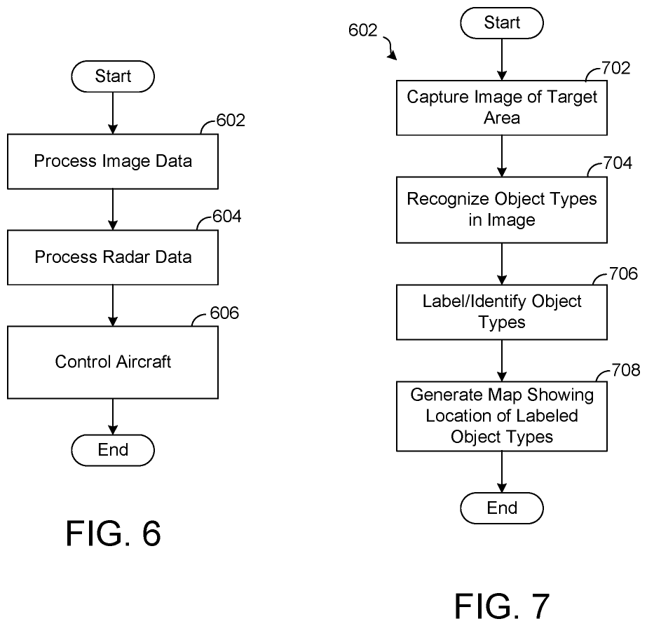

An exemplary use and operation of the system 5 in order to provide noise compensation to radar returns resulting from the transmission of radar signals toward the surface by the aircraft 10 will be described in more detail below with reference to FIGS. 6-8. For illustrative purposes, it will be assumed that the aircraft 10 is transmitting a radar signal toward the surface as shown in FIG. 9. In one embodiment, the aircraft 10 may transmit a radar signal toward the surface during operation in a cruise mode or in a landing mode. However, in other embodiments, the aircraft 10 may transmit a radar signal toward the surface in other modes of operation of the aircraft 10.

FIG. 6 shows an embodiment of a process for handling sensor data to control an aircraft by the sense and avoid element 207. The process begins by processing image data provided by image sensors 30 with computer vision logic 348 (step 602). Next, radar data generated from multiple radar samples provided by the radar sensor 20 is processed with radar logic 355 (step 604). As will be discussed in more detail below, the radar samples in the radar data can be processed by the radar logic 355 using information generated by the computer vision logic 348. The processed radar samples from radar logic 355 can then be used by the sense and avoid logic 350 to control the aircraft (step 606). In one embodiment, the sense and avoid logic 350 can generate a path for the aircraft 10 using the processed radar samples (or radar data), which is then provided to the aircraft control system 225.

FIG. 7 shows an embodiment of a process for processing image data from image sensors 30. In one embodiment, the process of FIG. 7 can be used to process the image data from step 602 of the process of FIG. 6, but the process of FIG. 7 may also be used to process image data for other applications in other embodiments. The process of FIG. 7 can begin with the capturing an image of a scene or target area (step 702) that is associated with the flight of the aircraft 10. Referring to FIG. 9, the aircraft 10 can have an image sensor 30 that can capture an image of a target area within a FOV defined within dashed lines A. The captured image can be similar to image 400 shown in FIG. 4 and can include, among other things, wooded area 402, mountainous area 404 and water area 406.

The captured image of the target area can be stored as image data in sensor data 343. The computer vision logic 348 can retrieve the stored image data corresponding to the target area and recognize one or more object types (e.g., single objects (or items) such as a tree or surface textures such as a group of similar items in close proximity to one another (e.g., a canopy formed from several trees)) within the target area (step 704). As discussed above, the computer vision logic 348 can use segmentation, pattern recognition, edge detection and/or any other suitable image processing techniques to recognize object types within the image. The recognized object types can then be labeled (step 706) to correspond a recognized object type from the image data to a specific object type. To assist with the labeling process, memory 320 can store information that relates a specific object type to a specific output from the computer vision logic 348. In one embodiment, the memory 320 can store information about each object type that may be encountered by the aircraft 10 within the corresponding flight area of the aircraft 10. Once all of the object types from the image have been identified (or labeled), a map of the target area can be generated (step 708) that shows the location of each of the labeled object types. The generated map can be similar to map 500 shown in FIG. 5 and can include, among other things, the locations of the wooded area 402, the mountainous area 404 and the water area 406 within the target area. Each labeled object type can be defined in the map in terms of a coordinate system such that each label object type corresponds to a plurality of coordinates in the coordinate system. In addition, the generated map can also indicate portions of the target area where an object type was unable to be recognized and/or labeled. Once the map with the locations of the labeled object types has been generated, the map can be saved in map data 340.

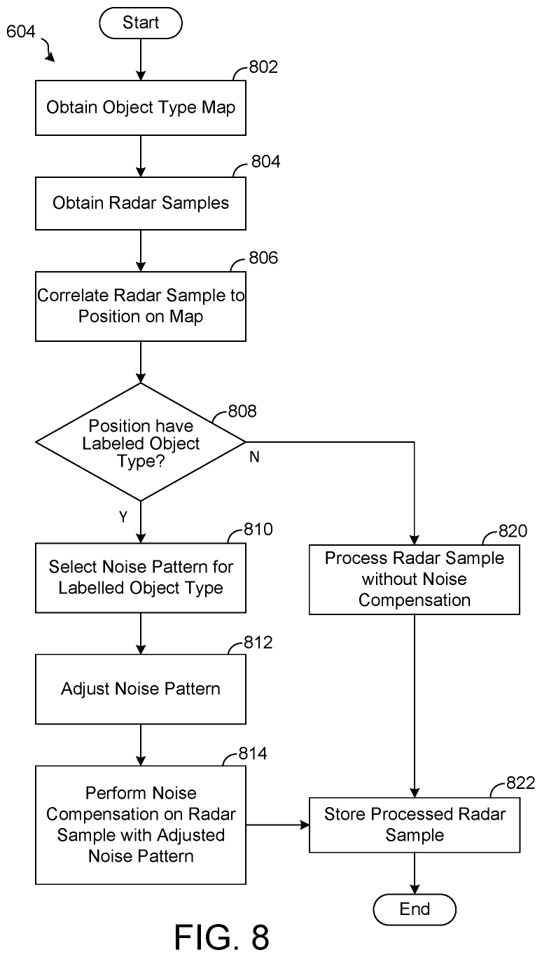

FIG. 8 is a flow chart illustrating a method for processing radar samples from radar sensor 20 in accordance with some embodiments of the present disclosure. In one embodiment, the process of FIG. 8 can be used to process the radar data generated from multiple radar samples from step 604 of the process of FIG. 6, but the process of FIG. 8 may also be used to process radar data generated from multiple radar samples for other applications in other embodiments. The process of FIG. 8 can begin with the radar logic 355 obtaining the map of the target area with the labeled object types (step 802). The radar logic 355 can either access the map from map data 344 or the computer vision logic 348 can provide the map to the radar logic 355. Next, the radar logic 355 can obtain the radar sample (step 804). Referring to FIG. 9, the aircraft 10 can have a radar sensor 20 that transmits a radar signal 902 and receives returns of the transmitted radar signal from a portion of the target area. The transmitted radar signal 902 can be swept through a field of regard (FOR) for the radar sensor 20 defined within dashed lines B. Each return received by the radar sensor 20 can be measured by the radar sensor 20 to generate a radar sample that is indicative of the return. The radar sensor 20 can store data associated with each of the radar samples (and corresponding data about the transmitted radar signal such as the position of the transmitted radar signal with respect to FOR B and the angle of incidence for the transmitted radar signal) as radar data in sensor data 343.

Once the radar logic 355 obtains a radar sample, the radar logic 355 can then attempt to remove noise from the radar sample that may be present in the radar sample as a result of the transmitted radar signal reflecting off of one or more object types on the surface (e.g., wooded area 402, mountainous area 404 or water area 406), which can sometimes be referred to as ground clutter. To remove the noise from the radar sample, the radar logic 355 may first identify the object type that may be introducing the noise into the radar sample. After identifying the object type that may be introducing the noise, the radar logic 355 can then select a noise pattern that corresponds to the noise introduced into the radar sample by the identified object type. Noise compensation data 347 can store noise patterns for each of the object types that may be identified by computer vision logic 348. In addition, since the noise introduced into the radar sample by the identified object type can vary based on the angle of incidence of the transmitted radar signal, the radar logic 355 can also adjust the noise pattern stored in noise compensation data 347 to account for variances in the angle of incidence of the transmitted radar signal. In one embodiment, the adjustment of the noise pattern can be performed as a function of the angle of incidence. In another embodiment, in place of adjusting a noise pattern to account for the angle of incidence, the noise compensation data 347 can store numerous noise patterns for a specific object type with the different noise patterns for an object type corresponding to different angles of incidence.

Referring back to FIG. 8, the radar logic 355, after obtaining the radar sample, can then correlate position information associated with the radar sample (e.g., the position of the transmitted radar signal that resulted in the radar sample) to a corresponding position in the map (step 806). In other words, the radar logic 355 can convert location information associated with the radar sample to position information (e.g., coordinates) that correspond to the coordinate system of the map. The radar logic 355 can then determine if the position on the map associated with the radar sample corresponds to the location of a labeled object type on the map (step 808) that may have introduced noise into the radar sample. In one embodiment, FOR B associated with radar sensor 20 can be correlated to the portion of the FOV A associated with the image sensor 30 such that position information associated with the radar sample can correspond to coordinates in the coordinate system associated with the map.

If the radar logic 355 identifies a labeled object type from the map that corresponds to the position associated with the radar sample, the radar logic 355 can then select a corresponding noise pattern (or noise signature) from noise compensation data 347 for the identified object type (step 810). In an embodiment, noise compensation data 347 can store a corresponding noise pattern for each object type that may be identified by the computer vision logic 348. The radar logic 355 can then adjust the selected noise pattern to account for variances in the noise in the radar sample (step 812) that may occur as a result of the angle of incidence in the transmitted radar signal or other conditions that may alter the noise in the radar sample introduced by the object type. The radar logic 355 can then perform noise compensation on the radar sample with the adjusted noise pattern (step 814) and then store the compensated radar sample (step 822) in memory 320. Referring back to step 808, if the radar logic 355 cannot identify a labeled object type from the map that corresponds to the position associated with the transmitted radar signal (and radar sample) or if the map indicates that an unidentified or unknown object type corresponds to the position associated with the radar sample, the radar logic 355 can then process the radar sample without noise compensation (step 820) and then store the processed radar sample (step 822). While the process of FIG. 8 has been described with respect to the processing of an individual radar sample, the process of FIG. 8 can be repeated for each radar sample provided by the radar sensor 20. The processing of each radar sample from the radar sensor 20, permits noise corresponding to different object types at different areas of the map to be removed from the radar samples.

The selection of noise patterns based on identified objects or surface textures from the map permits the radar logic 355 to remove noise associated with ground clutter from the radar samples. The removal of the noise associated with ground clutter from the radar data while an aircraft is in flight (e.g., cruising or landing) can permit the sense and avoid logic 350 to better identify the presence of objects in the path of the aircraft that would have been otherwise obscured by the noise associated with ground clutter in the radar samples. In addition, by removing the noise associated with the ground clutter in the radar samples, the sense and avoid logic 350 can more accurately detect objects in the flight path of the aircraft 10 and provide for a more efficient flight of the aircraft 10.

In another embodiment, the radar logic 355 can perform noise compensation based on the location and orientation of the aircraft 10 with respect to a known flight path of the aircraft 10. The radar logic 355 can receive location and orientation data for the aircraft 10 from one or more sensors 30 (e.g., a GPS sensor) or systems (e.g., inertial navigation systems (INS), and/or global navigation satellite system (GNSS)). The radar logic 355 can then use the location and orientation information for the aircraft 10 to select a predefined map of the area and identify an object type from the predefined map that may introduce noise into the radar sample. After identifying the object type from the predefined map, the radar logic 355 can select a noise pattern based on the identified object type and perform corresponding adjustments to the selected noise pattern based on the angle of incidence of the transmitted radar signal. Memory 320 can store noise patterns in noise compensation data 347 that correspond to each of the identified object types at each of the possible locations of the aircraft 10 along its intended flight path. The selection of a noise pattern based on the location of the aircraft 10 can be used in addition to or in place of the selection of a noise pattern based on image data.

Although the figures herein may show a specific order of method steps, the order of the steps may differ from what is depicted. Also, two or more steps may be performed concurrently or with partial concurrence. It should be understood that the identified embodiments are offered by way of example only. Other substitutions, modifications, changes and omissions may be made in the design, operating conditions and arrangement of the embodiments without departing from the scope of the present application. Accordingly, the present application is not limited to a particular embodiment, but extends to various modifications that nevertheless fall within the scope of the application. It should also be understood that the phraseology and terminology employed herein is for the purpose of description only and should not be regarded as limiting.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications. Therefore, the disclosed subject matter should not be limited to any single embodiment described herein, but rather should be construed in breadth and scope in accordance with the appended claims.

What is claimed is:

1. A method comprising:
capturing an image of a scene with at least one image sensor on a vehicle;
transmitting a radar signal from a radar sensor on the vehicle;
measuring returns of the radar signal with the radar sensor thereby providing a plurality of radar samples, wherein each of the plurality of radar samples is indicative of a measured return of the radar signal from a respective point in the scene;
identifying, based on the captured image, a type of object to which the radar signal is directed for at least one of the radar samples;
selecting a predefined noise pattern associated with the identified type of object; and
compensating the at least one of the radar samples based on the selected predefined noise pattern.

2. The method of claim 1, further comprising:
determining an angle of incidence for the at least one radar sample; and
adjusting the predefined noise pattern based on the determined angle of incidence.

3. The method of claim 1, wherein the identifying a type of object includes performing at least one of segmentation, pattern recognition or edge detection on image data corresponding to the captured image.

4. A method for removing noise from radar samples, the method comprising:
receiving a radar return with a radar sensor on a vehicle, the radar sensor configured to provide a radar sample corresponding to the radar return;
associating the radar return with an area of a map;
identifying at least one type of object within a geographic region represented by the area on the map;
selecting a noise pattern based on the identified object type; and
compensating the radar sample based on the selected noise pattern.

5. The method of claim 4, further comprising:
capturing an image of the target area with an image sensor on the vehicle; and
defining the map based on the captured image.

6. The method of claim 4, wherein the compensating the radar sample includes adjusting the selected noise pattern based on an angle of incidence associated with the radar sample.

7. The method of claim 4, wherein the compensating the radar sample includes mathematically combining the radar sample with the selected noise pattern.

8. A vehicle monitoring system comprising:
at least one image sensor positioned on a vehicle and configured to capture an image of a target area, the captured image defined by image data;
at least one radar sensor positioned on the vehicle and configured to receive a radar return from a portion of the target area, the at least one radar sensor configured to provide a radar sample corresponding to the received radar return; and
at least one processor configured to receive the image data from the at least one sensor and the radar sample from the at least one radar sensor, the at least one processor configured to identify, based on the image data, at least one object type for the portion of the target area from which the radar return is received, and select a noise pattern based on the identified at least one object type, wherein the at least one processor is further configured to perform noise compensation on the radar sample based on the selected noise pattern.

9. The system of claim 8, wherein the at least one processor is further configured to adjust the selected noise pattern based on an angle of incidence associated with the radar return.

10. The system of claim 8, wherein the at least one processor is further configured to:
correlate the portion of the target area to coordinates on a map; and
determine whether the identified at least one object type is located at the coordinates.

11. The system of claim 8, wherein the at least one processor is further configured to perform the noise compensation by mathematically combining the received radar sample and the selected noise pattern.

12. The system of claim 8, further comprising a control system configured to control operation of the vehicle based on the radar sample.
